(19) United States
(12) Patent Application Publication
(10) Pub. No.: US 2024/0054061 A1
(43) Pub. Date: Feb. 15, 2024

(54) Method For Predicting Computing Cluster Error And Related Device

(71) Applicant: INSPUR SUZHOU INTELLIGENT TECHNOLOGY CO., LTD., Jiangsu (CN)

(72) Inventors: Kunlei CUI, Jiangsu (CN); Yu LIU, Jiangsu (CN)

(21) Appl. No.: 18/246,818

(22) PCT Filed: Jul. 30, 2021
(86) PCT No.: PCT/CN2021/109424

§ 371 Date: Mar. 27, 2023

(30) Foreign Application Priority Data
Oct. 27, 2020 (CN) 202011160403.4

(51) Int. Cl. G06F 11/34

(52) U.S. Cl. CPC G06F 11/3423; G06F 11/3457

(57) ABSTRACT

Provided are a method for predicting computing cluster error and a related device. The method comprises: classifying error types of a computing cluster according to historical information of the computing cluster; calculating and arranging, at a preset time interval, the number of occurrences of each error type of the computing cluster according to a preset sequence, wherein, the preset sequence is that a previous error type directly affects the occurrence of the proximate next error type; calculating, at the preset time interval, the probability of occurrence of each error type and the remaining probability of each error type at a next time interval; and according to the probability of occurrence of each error type and the remaining probability of each error type at the next time interval, performing error prediction on the computing cluster on the basis of a growth curve function mode.

### TECHNICAL FIELD

The present disclosure relates to the technical field of computing cluster, and in particular, to a method for predicting computing cluster error and a related device.

### BACKGROUND

The growing demand for large-scale scientific computing drives the rapid development of supercomputer systems. As the scale of a computer system increases, components of the computer system keep increasing, hardware and software structures become increasingly complex, working modes change rapidly, the number of users increases, the average failure-free time of the supercomputer system becomes shorter and shorter, and reliability problems become increasingly prominent. Cluster management and error solutions for large-scale computing clusters that form the above supercomputer system pose a huge challenge to cluster administrators.

Currently, an error prediction and management solution for the computing clusters is to calculate and analyze the error of the clusters on the basis of hardware power consumption conditions of each component of a computer cluster. However, the method requires a large amount of additional hardware for observing the power consumption of each node chip and overall power consumption, which is a huge cost for the computing clusters with tens of thousands of nodes, also increases the implementation complexity of the computing clusters and adds additional expertise requirements for administrators.

### SUMMARY

An embodiment of the present disclosure provides a method for predicting computing cluster error. The method includes the following operations.

Error types of a computing cluster are classified according to historical information of the computing cluster.

At a preset time interval, a number of occurrences of each error type of the computing cluster is calculated and arranged according to a preset sequence, where the preset sequence is that a previous error type directly affects the occurrence of a proximate next error type.

At the preset time interval, a probability of occurrence of each error type and a remaining probability of each error type at a next time interval are calculated.

According to the probability of occurrence of each error type and the remaining probability of each error type at the next time interval, error prediction is performed on the computing cluster on the basis of a growth curve function model, so as to obtain a number of occurrences of each error type of the computing cluster in the future.

In some embodiments, the error type includes: basic errors, hardware errors and exceptions, system-level errors and exceptions, disclosure exceptions and node exceptions, wherein the previous error type directly affects the occurrence of the proximate next error type.

In some embodiments, the remaining probability of the error type is the probability that the error of the error type is not solved within the current time interval and is then remained until the next time interval; and the error of the error type that is remained at the next time interval directly affects the occurrence of the proximate next error type of the error type within the next time interval.

In some embodiments, the operation of according to the probability of occurrence of each error type and the remaining probability of each error type at the next time interval, performing error prediction on the computing cluster on the basis of the growth curve function model, so as to obtain the number of occurrences of each error type of the computing cluster in the future includes the following operation.

According to the probability of occurrence of each error type and the remaining probability of each error type at the next time interval, error prediction is performed on the computing cluster on the basis of the growth curve function model, so as to obtain the number of occurrences of each error type of the computing cluster in the future.

In some embodiments, the time interval is one week.

In some embodiments, a statistical window period of the historical information of the computing cluster is one year.

In some embodiments, before the operation of according to the probability of occurrence of each error type and the remaining probability of each error type at the next time interval, performing error prediction on the computing cluster on the basis of the growth curve function model, so as to obtain the number of occurrences of each error type of the computing cluster in the future, the method further includes the following operation.

The probability of occurrence of each error type and the remaining probability of each error type at the next time interval are updated.

A second aspect of an embodiment of the present disclosure provides a device for predicting computing cluster error. The device includes a classification unit, a sorting unit, a statistic unit and a prediction unit.

The classification unit is configured to classify error types of a computing cluster according to historical information of the computing cluster.

The sorting unit is configured to calculate and arrange, at a preset time interval, the number of occurrences of each error type of the computing cluster according to a preset sequence, where the preset sequence is that a previous error type directly affects the occurrence of the proximate next error type.

The statistic unit is configured to calculate, at the preset time interval, the probability of occurrence of each error type and the remaining probability of each error type at a next time interval.

The prediction unit is configured to, according to the probability of occurrence of each error type and the remaining probability of each error type at the next time interval, perform error prediction on the computing cluster on the basis of a growth curve function model, so as to obtain the number of occurrences of each error type of the computing cluster in the future.

A third aspect of an embodiment of the present disclosure provides an electronic device. The electronic device includes a memory and a processor. The processor is configured, when executing a computer program stored in the memory, to implement steps of the above method for predicting computing cluster error.

A fourth aspect of an embodiment of the present disclosure provides a computer-readable storage medium. The computer-readable storage medium stores a computer program. Steps of the above method for predicting computing cluster error are implemented when the computer program is executed by a processor.

Correspondingly, the electronic device and the computer-readable storage medium provided in the embodiments of the present invention also have the same technical effects.

### BRIEF DESCRIPTION OF THE DRAWINGS

FIG. 1 is a schematic flowchart of a possible method for predicting computing cluster error according to an embodiment of the present disclosure.

FIG. 2 is a schematic structural block diagram of a possible device for predicting computing cluster error according to an embodiment of the present disclosure.

FIG. 3 is a schematic diagram of a hardware structure of a possible device for predicting computing cluster error according to an embodiment of the present disclosure.

FIG. 4 is a schematic structural block diagram of a possible electronic device according to an embodiment of the present disclosure.

FIG. 5 is a schematic structural block diagram of a possible computer-readable storage medium according to an embodiment of the present disclosure.

### DETAILED DESCRIPTION OF THE EMBODIMENTS

Embodiments of the present disclosure provide a method for predicting computing cluster error and a related device, which may perform error prediction of a computing cluster at low cost and high efficiency.

Terms “first”, “second”, “third”, “fourth” and the like (if exists) in the description, claims and the above drawings of the present disclosure are used for distinguishing similar objects rather than describing a specific sequence or a precedence order. It should be understood that the data used in such a way may be exchanged where appropriate, in order that the embodiments described here can be implemented in an order other than those illustrated or described herein. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead. The technical solutions in the embodiments of the present disclosure will be clearly and completely described below in combination with the drawings in the embodiments of the present disclosure. It is apparent that the described embodiments are only part of the embodiments of the present disclosure, not all the embodiments.

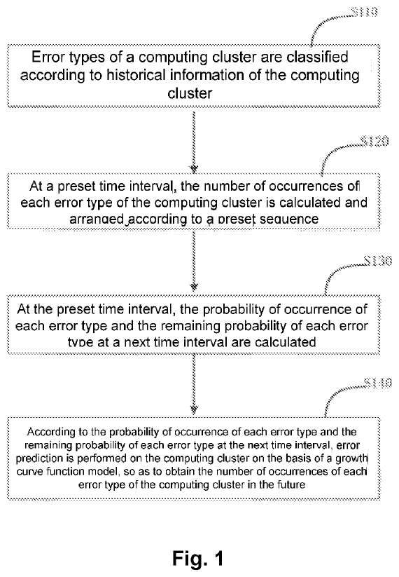

FIG. 1 is a flowchart of a method for predicting computing cluster error according to an embodiment of the present disclosure. The method may include: S110-S140.

At S110, error types of a computing cluster are classified according to historical information of the computing cluster.

It is to be noted that, since an error cannot be isolated, it have a cause that leads to the error, and the occurrence of the error must also have certain subsequent adverse effects, it is important to pay attention to the causal relationship before and after an error type when the error type of a known computing cluster is classified. Under a condition that an error or exception in one error type is not solved in a timely manner, the probability of occurrence of subsequent error types is directly caused or exacerbated. In addition, since the error or exception in the error type has already occurred, the error or exception has more or less adversely affected the previous most basic error type. It can be seen that, the errors of the computing cluster consistent with a growth curve function model.

Exemplarily, a statistical window period of the historical information of the computing cluster may be one year. In order to obtain sufficient data samples, the statistical window period needs to be relatively long, which may be one year, two years or more. Definitely, under a condition that a data condition is limited, a relatively short period of time may be selected.

At S120, at a preset time interval, the number of occurrences of each error type of the computing cluster is calculated and arranged according to a preset sequence, wherein the preset sequence is that a previous error type directly affects the occurrence of the proximate next error type.

In some examples, the calculated number of occurrences of each error type may be expressed as: x=(x₁, x₂, . . . , xₙ)^{T}, that is, a distribution vector of each error type. Each error type is arranged in order, an xₙ-type error directly affects an xₙ₊₁-type error, that is to say, a previous error type directly affects the occurrence of the proximate next error type.

Exemplarily, one week may be taken as a statistical time interval; and the number of weeks is recorded as k, that is to say, observation and calculation are performed once a week, without considering the changes within the same time interval, and the time may be discretized. Initial time is set to 0, and then an error distribution vector of the error type over time may be recorded as x^{(k)}=(x₁^{(k)}, x₂^{(k)}, . . . , xₙ^{(k)})^{T}.

At S130, at the preset time interval, the probability of occurrence of each error type and the remaining probability of each error type at a next time interval are calculated.

Exemplarily, by means of taking one week as a time interval, all time interval periods within the statistical window period are integrated, and then the probability of occurrence of each error type xᵢ is calculated and recorded as aᵢ (aᵢ>=0). In addition, by means of taking one week as the time interval, all time interval periods within the statistical window period are integrated, and then the remaining probability of each error type xi at the next time interval is calculated and recorded as bᵢ (bᵢ>=0).

In some embodiments, the remaining probability of the error type is the probability that the error of the error type is not solved within the current time interval and is then remained until the next time interval; and the error of the error type that is remained at the next time interval directly affects the occurrence of the proximate next error type of the error type within the next time interval. For example, since a type i error cannot be solved within the current time interval due to various reasons and is then remained to the next time interval, the remained error directly affects a type i+1 error within the next time interval.

At S140, according to the probability of occurrence of each error type and the remaining probability of each error type at the next time interval, error prediction is performed on the computing cluster on the basis of a growth curve function model, so as to obtain the number of occurrences of each error type of the computing cluster in the future.

Exemplarily, it can be considered that the number of first-type errors x₁ at k is indirectly affected by all error types at k−1, and a total number may be estimated as:

x₁^{(k)}=a₁x₁^{(k-1)}+a₂x₂^{(k-1)}+ . . . +aₙxₙ^{(k-1)}

In addition, the number xᵢ₊₁^{(k)} of type i+1 errors at k is the accumulation of the x set of errors at k−1 over k periods, and may be represented by the following equations:

The above two equations may be represented by means of a matrix.

$$( \begin{matrix}\text{?} \\ \text{?} \\ \text{?} \\ ⋯ \\ \text{?}\end{matrix} ) = ( \begin{matrix}{a}_{1} & {a}_{2} & ⋯ & \text{?} & \text{?} \\ {b}_{1} & 0 & ⋯ & 0 & 0 \\ 0 & {b}_{2} & ⋯ & ⋯ & ⋯ \\ ⋯ & ⋯ & ⋯ & 0 & 0 \\ 0 & ⋯ & 0 & \text{?} & 0\end{matrix} ) ( \begin{matrix}\text{?} \\ \text{?} \\ \text{?} \\ ⋯ \\ \text{?}\end{matrix} )$$

$$\text{?} \text{indicates text missing or illegible when filed}$$

Under a condition that

$$L = ( \begin{matrix}{a}_{1} & {a}_{2} & ⋯ & \text{?} & \text{?} \\ {b}_{1} & 0 & ⋯ & 0 & 0 \\ 0 & {b}_{2} & ⋯ & ⋯ & ⋯ \\ ⋯ & ⋯ & ⋯ & 0 & 0 \\ 0 & ⋯ & 0 & \text{?} & 0\end{matrix} ) , \text{?} = ( \begin{matrix}\text{?} \\ \text{?} \\ \text{?} \\ ⋯ \\ \text{?}\end{matrix} )$$

$$\text{?} \text{indicates text missing or illegible when filed}$$

is recorded, x^{k}=L^{k}x⁰.

A matrix L may be called a growth curve function model matrix, such that the number of errors of each error type after k periods is calculated.

To sum up, according to the method for predicting computing cluster error provided in the above embodiments, the error types of the computing cluster are classified according to the historical information of the computing cluster; at the preset time interval, the number of occurrences of each error type of the computing cluster is calculated and arranged according to the preset sequence, where the preset sequence is that the previous error type directly affects the occurrence of the proximate next error type; at the preset time interval, the probability of occurrence of each error type and the remaining probability of each error type at the next time interval are calculated; and according to the probability of occurrence of each error type and the remaining probability of each error type at the next time interval, error prediction is performed on the computing cluster on the basis of the growth curve function model, so as to obtain the number of occurrences of each error type of the computing cluster in the future. By means of using a hierarchical before and after correlation of each error type of the computing cluster to calculate historical error types of the computing cluster, and performing efficient error prediction on the computing cluster in combination with the growth curve function model, a computing cluster manager takes preventive measures. In addition, as the above solutions do not need other hardware facilities, prediction cost can be greatly reduced.

In some embodiments, the error type may include: basic errors, hardware errors and exceptions, system-level errors and exceptions, application exceptions and node exceptions, where the previous error type directly affects the occurrence of the proximate next error type.

The basic errors may be the weakening of the overall electrical characteristics of a machine, accelerated aging of components (overuse caused by heat dissipation, dust, power supply exceptions, major hardware component exceptions, system exceptions, application exceptions), and errors and exceptions that are not described in detail and may be included in this category.

The hardware errors and exceptions may include hardware errors and exceptions related to major components, such as memory read errors, Central Processing Unit (CPU) core deadlock, power supply exceptions, network card exceptions and hard disk exceptions, as well as errors and exceptions that are not described in detail and may be included in this category.

The system-level errors and exceptions may include system service exceptions, system kernel bugs, cluster scheduling system exceptions, and system management exceptions for hardware resources, as well as errors and exceptions that are not described in detail and may be included in this category.

The application exceptions may include application exceptions that result in large usage of a single system resource, exceptions that libraries called by applications cannot release system resources in a timely manner, and zombie processes, as well as errors and exceptions that are not described in detail and may be included in this category.

The node exceptions may include the instance that an entire node cannot be operated normally.

According to some embodiments, before the step of according to the probability of occurrence of each error type and the remaining probability of each error type at the next time interval, performing error prediction on the computing cluster on the basis of the growth curve function model, so as to obtain the number of occurrences of each error type of the computing cluster in the future, the method further includes the following operation.

The probability of occurrence of each error type and the remaining probability of each error type at the next time interval are updated. Since the probability ai of error occurrence and the remaining probability bi of each error type may be dynamically adjusted with actual statistical data of a statistical period k, the accuracy of error prediction can be improved.

The above describes the method for predicting computing cluster error in the embodiments of the present disclosure, and a device for predicting computing cluster error in the embodiments of the present disclosure is described below.

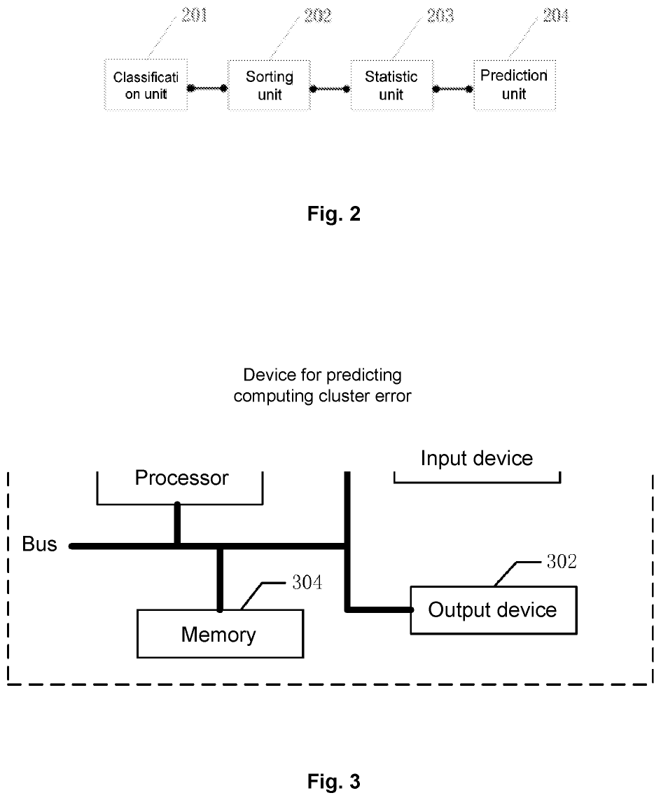

FIG. 2 is an embodiment of a device for predicting computing cluster error according to an embodiment of the present disclosure. The device may include a classification unit, a sorting unit, a statistic unit and a prediction unit.

The classification unit 201 is configured to classify error types of a computing cluster according to historical information of the computing cluster.

The sorting unit 202 is configured to calculate and arrange, at a preset time interval, the number of occurrences of each error type of the computing cluster according to a preset sequence, where the preset sequence is that a previous error type directly affects the occurrence of the proximate next error type.

The statistic unit 203 is configured to calculate, at the preset time interval, the probability of occurrence of each error type and the remaining probability of each error type at a next time interval.

The prediction unit 204 is configured to, according to the probability of occurrence of each error type and the remaining probability of each error type at the next time interval, perform error prediction on the computing cluster on the basis of a growth curve function model, so as to obtain the number of occurrences of each error type of the computing cluster in the future.

To sum up, according to the device for predicting computing cluster error provided in the embodiments of the present disclosure, the error types of the computing cluster are classified according to the historical information of the computing cluster; at the preset time interval, the number of occurrences of each error type of the computing cluster is calculated and arranged according to the preset sequence, where the preset sequence is that the previous error type directly affects the occurrence of the proximate next error type; at the preset time interval, the probability of occurrence of each error type and the remaining probability of each error type at the next time interval are calculated; and according to the probability of occurrence of each error type and the remaining probability of each error type at the next time interval, error prediction is performed on the computing cluster on the basis of the growth curve function model, so as to obtain the number of occurrences of each error type of the computing cluster in the future. By means of using a hierarchical before and after correlation of each error type of the computing cluster to calculate historical error types of the computing cluster, and performing efficient error prediction on the computing cluster in combination with the growth curve function model, a computing cluster manager takes preventive measures. In addition, as the above solutions do not need other hardware facilities, prediction cost can be greatly reduced.

In FIG. 2 above, the device for predicting computing cluster error in the embodiments of the present disclosure is described from the perspective of a modular functional entity. The device for predicting computing cluster error in the embodiments of the present disclosure is described in detail from the perspective of hardware processing. FIG. 3 is an embodiment of a device for predicting computing cluster error 300 according to an embodiment of the present disclosure. The device includes an input device 301, an output device 302, a processor 303 and a memory 304.

There may be one or more processors 303. In FIG. 3, one processor 303 is used as an example. In some embodiments of the present disclosure, the input device 301, the output device 302, the processor 303 and the memory 304 may be connected by means of a bus or in other manners. In FIG. 3, connection by means of the bus is used as an example.

By means of calling an operation instruction stored in the memory 304, the processor 303 is configured to execute the following steps.

Error types of a computing cluster are classified according to historical information of the computing cluster.

At a preset time interval, the number of occurrences of each error type of the computing cluster is calculated and arranged according to a preset sequence, where the preset sequence is that a previous error type directly affects the occurrence of the proximate next error type.

At the preset time interval, the probability of occurrence of each error type and the remaining probability of each error type at a next time interval are calculated.

According to the probability of occurrence of each error type and the remaining probability of each error type at the next time interval, error prediction is performed on the computing cluster on the basis of a growth curve function model matrix, so as to obtain the number of occurrences of each error type of the computing cluster in the future.

By means of calling an operation instruction stored in the memory 304, the processor 303 is further configured to execute any manner in the embodiment corresponding to FIG. 1.

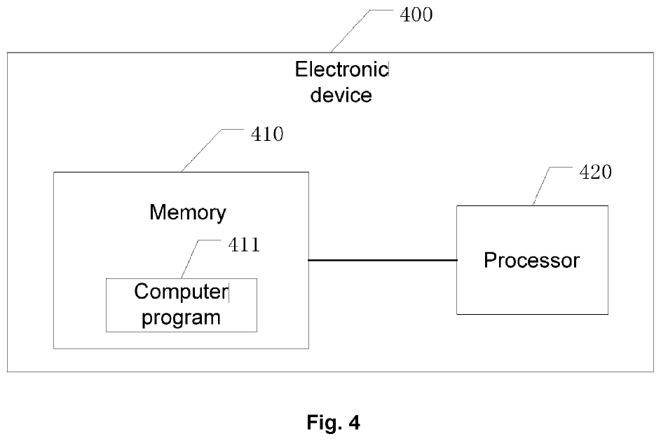

Referring to FIG. 4, FIG. 4 is a schematic embodiment diagram of an electronic device according to an embodiment of the present disclosure.

As shown in FIG. 4, an embodiment of the present disclosure provides an electronic device. The electronic device includes a memory 410, a processor 420, and a computer program 411 stored on the memory 420 and executable on the processor 420. The processor 420, when executing the computer program 411, implements the following steps.

Error types of a computing cluster are classified according to historical information of the computing cluster.

At a preset time interval, the number of occurrences of each error type of the computing cluster is calculated and arranged according to a preset sequence, where the preset sequence is that a previous error type directly affects the occurrence of the proximate next error type.

At the preset time interval, the probability of occurrence of each error type and the remaining probability of each error type at a next time interval are calculated.

According to the probability of occurrence of each error type and the remaining probability of each error type at the next time interval, error prediction is performed on the computing cluster on the basis of a growth curve function model matrix, so as to obtain the number of occurrences of each error type of the computing cluster in the future.

In a specific implementation, when the processor 420 executes the computer program 411, any implementation in the embodiments corresponding to FIG. 1 may be implemented.

Since the electronic device introduced in this embodiment is a device used for implementing the device for predicting computing cluster error in the embodiments of the present disclosure, on the basis of the method introduced in the embodiments of the present disclosure, those skilled in the art can understand the specific implementation of the electronic device of this embodiment and various variations thereof, such that the way that the electronic device implements the method in the embodiments of the present disclosure is not introduced in detail here, as long as devices used by those skilled in the art for implementing the method in the embodiments of the present disclosure all fall within the scope of the desired protection of the present disclosure.

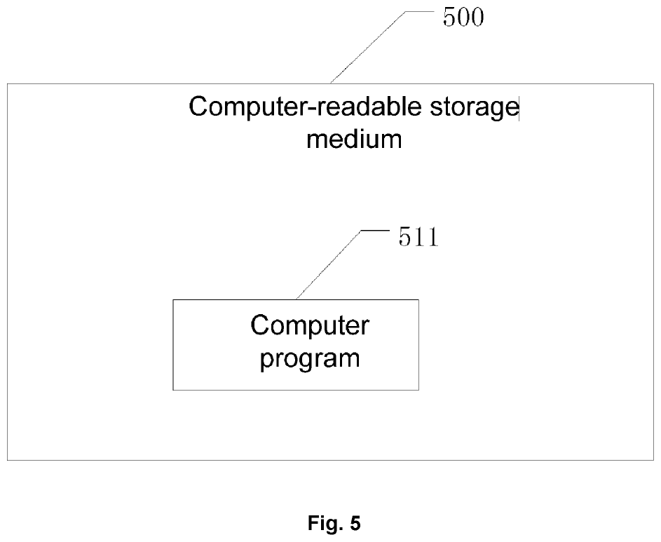

Referring to FIG. 5, FIG. 5 is a schematic diagram of an embodiment of a computer-readable storage medium according to an embodiment of the present disclosure.

As shown in FIG. 5, this embodiment provides a computer-readable storage medium 500. The computer-readable storage medium stores a computer program 511. The following steps are implemented when the computer program 511 is executed by a processor.

Error types of a computing cluster are classified according to historical information of the computing cluster.

At a preset time interval, the number of occurrences of each error type of the computing cluster is calculated and arranged according to a preset sequence, where the preset sequence is that a previous error type directly affects the occurrence of the proximate next error type.

At the preset time interval, the probability of occurrence of each error type and the remaining probability of each error type at a next time interval are calculated.

According to the probability of occurrence of each error type and the remaining probability of each error type at the next time interval, error prediction is performed on the computing cluster on the basis of a growth curve function model matrix, so as to obtain the number of occurrences of each error type of the computing cluster in the future.

In a specific implementation, when the computer program 511 is executed by the processor, any implementation in the embodiments corresponding to FIG. 1 may be implemented.

It is to be noted that, in the above embodiments, the description of each embodiment has its own focus. For parts that are not described in detail in a certain embodiment, reference may be made to related descriptions of other embodiments.

Persons skilled in the art should understand that the embodiments of the present disclosure may be provided as a method, a system, or a computer program product. Therefore, the present disclosure may adopt forms of complete hardware embodiments, complete software embodiments or embodiments integrating software and hardware. Moreover, the present disclosure may adopt the form of a computer program product implemented on one or more computer available storage media (including but being not limited to a disk memory, a Compact Disc Read Only Memory (CD-ROM), an optical memory, and the like) containing computer available program codes.

The present disclosure is described with reference to flowcharts and/or block diagrams of the method, the device (system) and the computer program product according to the embodiments of the present disclosure. It should be understood that each flow and/or block in the flowchart and/or block diagram, and the combination of the flow and/or block in the flowchart and/or block diagram can be implemented by the computer program instructions. These computer program instructions can be provided to a processor of a general-purpose computer, a special-purpose computer, an embedded computer or other programmable data processing devices to generate a machine, so that instructions which are executed by the processor of the computer or other programmable data processing devices generate a device which is used for implementing the specified functions in one or more flows of the flowchart and/or one or more blocks of the block diagram.

These computer program instructions may also be stored in the computer-readable memory which can guide the computer or other programmable data processing devices to work in a particular way, so that the instructions stored in the computer-readable memory generate a product including an instruction device. The instruction device implements the specified functions in one or more flows of the flowchart and/or one or more blocks of the block diagram.

These computer program instructions may also be loaded on the computer or other programmable data processing devices, so that a series of operation steps are performed on the computer or other programmable data processing devices to generate the processing implemented by the computer, and the instructions executed on the computer or other programmable data processing devices provide the steps for implementing the specified functions in one or more flows of the flowchart and/or one or more blocks of the block diagram.

An embodiment of the present disclosure further provides a computer program product. The computer program product includes a computer software instruction. When the computer software instruction is operated on a processing device, the processing device executes processes in the method for predicting computing cluster error in the embodiments corresponding to FIG. 1.

The computer program product includes one or more computer instructions. When the above computer program instruction is loaded and executed on a computer, the above processes or functions according to the embodiments of the present disclosure are generated in whole or in part. The above computer may be a general computer, a special computer, a computer network, or other programmable device. The above computer instruction may be stored in the computer-readable storage medium or transmitted from one computer-readable storage medium to another computer-readable storage medium. For example, the above computer instruction may be transmitted from a website site, a computer, a server, or a data center to another website site, another computer, another server, or another data center via wire (for example, a coaxial cable, an optical fiber, a Digital Subscriber Line (DSL)) or wireless (for example, infrared, wireless, microwave, or the like). The computer-readable storage medium may be any available medium that can be accessed by a computer, or a data storage device, such as a server and a data center, that includes one or more available mediums integrated. The above available medium may be a magnetic medium (for example, a floppy disk, a hard disk, and a magnetic tape), an optical medium (for example, DVD), or a semiconductor medium (for example, Solid State Disk (SSD)), and the like.

Those skilled in the art may clearly learn about that specific working processes of the system, device, and units described above may refer to the corresponding processes in the above method embodiments and will not be elaborated herein for ease and briefness of description.

In several embodiments provided by the present disclosure, it is to be understood that the disclosed system, device and method may be implemented in other ways. For example, the device embodiment described above is only schematic, and for example, division of the units is only logic function division, and other division manners may be adopted during practical implementation. For another example, a plurality of units or components may be combined or integrated into another system, or some characteristics may be neglected or not executed. In addition, the displayed or discussed mutual coupling or direct coupling or communication connection may be indirect coupling or communication connection through some interfaces, devices or units, and may be in electrical, mechanical or other forms.

The units described as separate components may or may not be physically separated. The components displayed as units may or may not be physical units, that is, the components may be located in one place, or may be distributed on the plurality of network units. Part or all of the units may be selected according to actual requirements to achieve the purposes of the solutions of this embodiment.

In addition, the functional units in the various embodiments of the present disclosure may be integrated into one processing unit, or each unit may exist alone physically, or two or more than two units may be integrated into one unit. The above integrated unit can be implemented in the form of hardware, or can be implemented in the form of a software functional unit.

Under a condition that the integrated unit is implemented in the form of the software functional unit and sold or used as an independent product, it can be stored in the computer readable storage medium. Based on this understanding, the technical solutions of the present disclosure essentially or the parts that contribute to the prior art, all or part of the technical solutions can be embodied in the form of a software product. The computer software product is stored in a storage medium, including a plurality of instructions for causing a computer device (which may be a personal computer, a server, or a network device, and the like) to execute all or part of the steps of the method described in the various embodiments of the present disclosure. The storage medium includes: various media capable of storing program codes such as a U disk, a mobile Hard Disk Drive (HDD), a Read-Only Memory (ROM), a Random Access Memory (RAM), a magnetic disk or an optical disk.

In conclusion, the above various embodiments are only used to illustrate the technical solutions of the present disclosure and not used to limit the same. Although the present disclosure has been described in detail with reference to the foregoing embodiments, for those of ordinary skill in the art, they can still modify the technical solutions described in the foregoing embodiments, or equivalently replace part of the technical features; all these modifications and replacements shall not cause the essence of the corresponding technical solutions to depart from the spirit and the scope of the technical solutions of the embodiments of the present disclosure.

1. A method for predicting computing cluster error, comprising:
classifying error types of a computing cluster according to historical information of the computing cluster;
calculating and arranging, at a preset time interval, a number of occurrences of each error type of the computing cluster according to a preset sequence, wherein, the preset sequence is that a previous error type directly affects the occurrence of a proximate next error type;
calculating, at the preset time interval, a probability of occurrence of each error type and a remaining probability of each error type at a next time interval; and
according to the probability of occurrence of each error type and the remaining probability of each error type at the next time interval, performing error prediction on the computing cluster on the basis of a growth curve function model, so as to obtain a number of occurrences of each error type of the computing cluster in the future.

2. The method as claimed in claim 1, wherein the error type comprises at least one of: basic errors, hardware errors and exceptions, system-level errors and exceptions, application exceptions and node exceptions, wherein the previous error type directly affects the occurrence of the proximate next error type.

3. The method as claimed in claim 1, wherein the remaining probability of the error type is a probability that a error of the error type is not solved within a current time interval and is then remained until the next time interval; and the error of the error type that is remained at the next time interval directly affects the occurrence of the proximate next error type of the error type within the next time interval.

4. The method as claimed in claim 1, wherein the step of according to the probability of occurrence of each error type and the remaining probability of each error type at the next time interval, performing error prediction on the computing cluster on the basis of the growth curve function model, so as to obtain the number of occurrences of each error type of the computing cluster in the future comprises:
according to the probability of occurrence of each error type and the remaining probability of each error type at the next time interval, performing error prediction on the computing cluster on the basis of a growth curve function model-mat-Fix, so as to obtain the number of occurrences of each error type of the computing cluster in the future.

5. The method as claimed in claim 1, wherein the preset time interval is one week.

6. The method as claimed in claim 1, wherein a statistical window period of the historical information of the computing cluster is one year.

7. The method as claimed in claim 1, wherein before the step of according to the probability of occurrence of each error type and the remaining probability of each error type at the next time interval, performing error prediction on the computing cluster on the basis of the growth curve function model, so as to obtain the number of occurrences of each error type of the computing cluster in the future, the method comprises:
updating the probability of occurrence of each error type and the remaining probability of each error type at the next time interval.

8. (canceled)

9. An electronic device, comprising a memory and a processor, wherein the processor is configured, when executing a computer program stored in the memory, to cause the processor to:
classify error types of a computing cluster according to historical information of the computing cluster;
calculate and arranging, at a preset time interval, a number of occurrences of each error type of the computing cluster according to a preset sequence, wherein, the preset sequence is that a previous error type directly affects the occurrence of a proximate next error type;
calculate, at the preset time interval, a probability of occurrence of each error type and a remaining probability of each error type at a next time interval; and
according to the probability of occurrence of each error type and the remaining probability of each error type at the next time interval, perform error prediction on the computing cluster on the basis of a growth curve function model, so as to obtain a number of occurrences of each error type of the computing cluster in the future.

10. A non-transitory storage medium, having a computer program that when performed by a processor, causes the processor to:
classify error types of a computing cluster according to historical information of the computing cluster;
calculate and arranging, at a preset time interval, a number of occurrences of each error type of the computing cluster according to a preset sequence, wherein, the preset sequence is that a previous error type directly affects the occurrence of a proximate next error type;
calculate, at the preset time interval, a probability of occurrence of each error type and a remaining probability of each error type at a next time interval; and
according to the probability of occurrence of each error type and the remaining probability of each error type at the next time interval, perform error prediction on the computing cluster on the basis of a growth curve function model, so as to obtain a number of occurrences of each error type of the computing cluster in the future.

11. The method as claimed in claim 2,
wherein the basic errors comprises at least of: weakening of the overall electrical characteristics of a machine, accelerated aging of components;
the hardware errors and exceptions comprises at least of: memory read errors, CPU core deadlock, power supply exceptions, network card exceptions and hard disk exceptions;
the system-level errors and exceptions comprises at least one of: system service exceptions, system kernel bugs, cluster scheduling system exceptions, and system management exceptions for hardware resources;
the application exceptions comprises at least one of: application exceptions that result in large usage of a single system resource, exceptions that libraries called by applications cannot release system resources in a timely manner, and zombie processes.

12. The device as claimed in claim 9, wherein the error type comprises at least one of: basic errors, hardware errors and exceptions, system-level errors and exceptions, application exceptions and node exceptions, wherein the previous error type directly affects the occurrence of the proximate next error type.

13. The device as claimed in claim 9, wherein the remaining probability of the error type is a probability that a error of the error type is not solved within a current time interval and is then remained until the next time interval; and the error of the error type that is remained at the next time interval directly affects the occurrence of the proximate next error type of the error type within the next time interval.

14. The device as claimed in claim 9, wherein the processor is further configured to:
according to the probability of occurrence of each error type and the remaining probability of each error type at the next time interval, perform error prediction on the computing cluster on the basis of a growth curve function model, so as to obtain the number of occurrences of each error type of the computing cluster in the future.

15. The device as claimed in claim 9, wherein the preset time interval is one week.

16. The device as claimed in claim 9, wherein a statistical window period of the historical information of the computing cluster is one year.

17. The non-transitory storage medium as claimed in claim 10, wherein a statistical window period of the historical information of the computing cluster is one year.

18. The non-transitory storage medium as claimed in claim 10, wherein the remaining probability of the error type is a probability that a error of the error type is not solved within a current time interval and is then remained until the next time interval; and the error of the error type that is remained at the next time interval directly affects the occurrence of the proximate next error type of the error type within the next time interval.

19. The non-transitory storage medium as claimed in claim 10, wherein the processor is further caused to:
according to the probability of occurrence of each error type and the remaining probability of each error type at the next time interval, perform error prediction on the computing cluster on the basis of a growth curve function model, so as to obtain the number of occurrences of each error type of the computing cluster in the future.

20. The non-transitory storage medium as claimed in claim 10, wherein the preset time interval is one week.

21. The non-transitory storage medium as claimed in claim 10, wherein a statistical window period of the historical information of the computing cluster is one year.
